(19) United States
(12) Patent Application Publication
(10) Pub. No.: US 2005/0289466 A1
(43) Pub. Date: Dec. 29, 2005

(54) Multimedia authoring method and system using bi-level theme templates

(76) Inventor: Kaihu Chen, Taichung City (TW)

Correspondence Address: BIRCH STEWART KOLASCH & BIRCH, PO BOX 747, FALLS CHURCH, VA, 22040-0747, US

(21) Appl. No.: 10/874,285

(22) Filed: Jun. 24, 2004

(51) Int. Cl. G06F 9/00; G06F 3/00

(52) U.S. Cl. 715/731; 715/853

(57) ABSTRACT

A multimedia authoring method and system using theme templates. First, a multimedia template database including a plurality of theme templates is provided, each theme template including a menu template and a visual content template, and both including predetermined menu and visual content parameters respectively. Next, multimedia data is obtained. One theme template is selected according to user control and a menu template and a visual content template of the selected theme template are applied to the multimedia data respectively.

### BACKGROUND

The present invention relates to disc creation, and in particular to a theme template structure for a computer-implemented multimedia authoring method and system.

Multimedia content stored in Video Compact Disc (VCD), Super VCD (SVCD), and Digital Versatile Disc (DVD) has heretofore been created by designing one layout structure and a physical operation per title, preparing and selecting material information to be used, then loading the layout structure and the physical operation while arranging the material information in a display space using an application-based authoring tool.

Conventional techniques related to multimedia authoring enable multimedia settings by manual adjustment. A conventional template structure for multimedia (photo and video) authoring saves time customizing the VCD/SVCD/DVD menu. Manual addition or adjustment of slideshow duration, transition effects, and background music, as well as the behaviors on setting menu background image and menu background music are enabled thereby.

A conventional menu template includes menu text, frame, layout, and background image/video, and is efficient and easy to use. Such an authoring method, however, using the menu template, is still time-consuming. It is still desirable to provide an authoring method with faster, easier, and more efficient adjustment.

### SUMMARY

Accordingly, an object of the present invention is to provide a multimedia authoring system using theme templates, enabling application of theme templates to multimedia data to simplify the workflow in multimedia authoring.

According to the object described, embodiments of the present invention provide a multimedia authoring method using theme templates. A multimedia template database comprising a plurality of theme templates is provided, in which each theme template comprises a menu template and a visual content template, for example, a slideshow or video template, in which both menu and visual content templates comprise predetermined menu and visual content parameters respectively. A slideshow template is applied in static multimedia files while a video template is applied in dynamic ones. Next, multimedia data is obtained. One theme template is selected according to a user operation and a menu template and a visual content template of the selected theme template are applied to the multimedia data respectively.

Embodiments of the present invention further provide a multimedia authoring system using theme templates, comprising a multimedia template database and a data processing unit. The multimedia template database includes a plurality of theme templates, each of which comprises a menu template and a visual content template, including slideshow and video templates, both templates comprising predetermined menu and visual content parameters respectively. The data processing unit selects one theme template according to a user operation and applies a menu template and a visual content template of the selected theme template to an obtained multimedia data respectively.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is a schematic diagram showing the theme template structure of an embodiment of the present invention;

FIG. 1B is a schematic diagram showing menu parameters of the theme template of an embodiment of the present invention;

FIG. 1C is a schematic diagram showing visual content parameters of the theme template of an embodiment of the present invention;

FIG. 2 is a flowchart showing the multimedia authoring method of an embodiment of the present invention;

FIG. 3 is a schematic diagram showing the architecture of the multimedia authoring system of an embodiment of the present invention;

FIG. 4 is a schematic diagram showing a user interface for applied theme templates of an embodiment of the present invention;

FIG. 5 is a schematic diagram showing a visual content authoring interface relating to menu authoring of an embodiment of the present invention;

FIG. 6 is a schematic diagram showing a visual content authoring interface relating to slideshow authoring of an embodiment of the present invention; and

FIG. 7 is a schematic diagram showing a visual content authoring interface relating to video authoring of an embodiment of the present invention.

### DETAILED DESCRIPTION

The present invention discloses a multimedia authoring method and system using theme templates.

An embodiment of the present invention is directed to a theme template structure used in a multimedia authoring system for image and video files. The theme template is a bi-level structure, applied in menu and visual content templates, compared with conventional single menu structure. Menu and visual content templates, while individual objects, are cooperative in multimedia authoring.

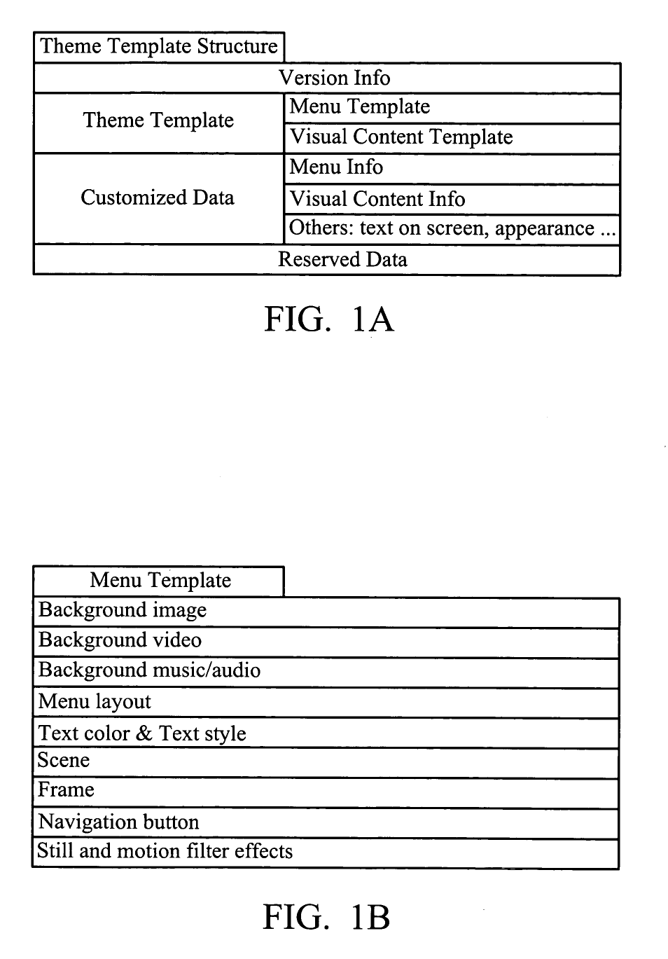

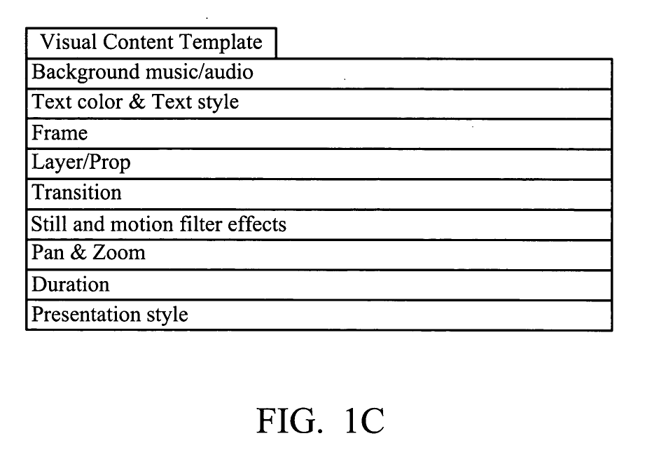

As shown in FIG. 1A, the theme template structure comprises a theme template and customized data, the theme template including a menu template and a visual content template, a video or slideshow template, and the customized data comprising menu and visual content settings and other data settings for manual modification.

As shown in FIG. 1B, the menu template requires parameters such as background image/background video, navigation button, menu layout, scene, frame, text color and text style, background music/audio, still and motion filter effects, and other multimedia links.

A background image or background video applies an image or video file to a theme template for background display. Navigation buttons enable menu pages to move forward or backward to be displayed in a preview window. A menu layout provides menu items grouped according to easily recognizable logical relationships. A scene button, similar to a menu page, comprises slices with static or dynamic image or video files, displaying multimedia data of a project. A frame surrounds a scene, which provides regular shapes, such as quadrangle or pentagon, or irregular shapes. Text color and text style provide different fonts and colors for appropriate text patterns. The background music/audio, similar to background image or video, applies a music or audio file to a theme template for background display. Still and motion filters offer static objects dynamic sustained effects.

As shown in FIG. 1C, the visual content template requires, respectively, parameters such as transition, duration, background music/audio, text color and text style, frame, layer, prop, still and motion filter effects, Pan and Zoom, and presentation style.

A transition effect is used to gradually go from one multimedia object to another. A duration, which lasts “until time T”, ends right before that time starts, and right before handling things that happen at that time. A background music/audio, similar to that of the menu template, applies a music or audio file to a theme template for background display. Text color and text style, similar to that of the menu template, provide different fonts and colors for appropriate text patterns. A frame, similar to that of the menu template, surrounds a scene, which provides regular shapes, such as quadrangle or pentagon, or irregular shapes. Layers are used for layout and animation design. Still and motion filters, similar to that of the menu template, offer static objects dynamic sustained effects. Pan and Zoom effects move, magnify (zoom out), and minify (zoom in) multimedia objects. A prop provides decorative objects. Presentation style gives individual scenery and theme for application.

As described above, the theme template is a bi-level structure, which menu and visual content involved in are individual objects. Presets in both menu and visual content templates are applied respectively once a theme template is selected for application to multimedia data, as such shortens the workflow in multimedia authoring. In addition, users can also customize menu and visual content settings respectively for requirements.

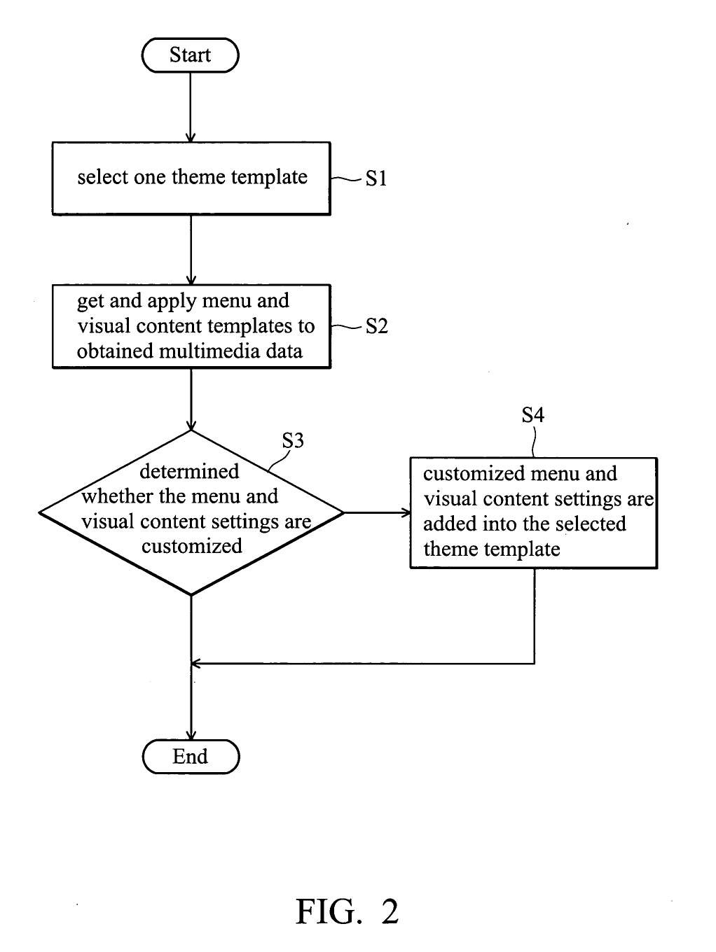

FIG. 2 is a flowchart showing the multimedia authoring method of an embodiment of the present invention, applying the theme templates to a created project.

In step S1, to edit image or video files, a theme template is selected from a bi-level theme template structure. Theme templates may have different topics.

In step S2, the authoring system acquires the preset settings from both menu and visual content templates for application to obtained multimedia data.

In step S3, it is determined whether the menu and visual content settings have been customized. If so, the process goes to step S4, and, if not, the process concludes.

In step S4, customized menu and visual content settings are added to the selected theme template.

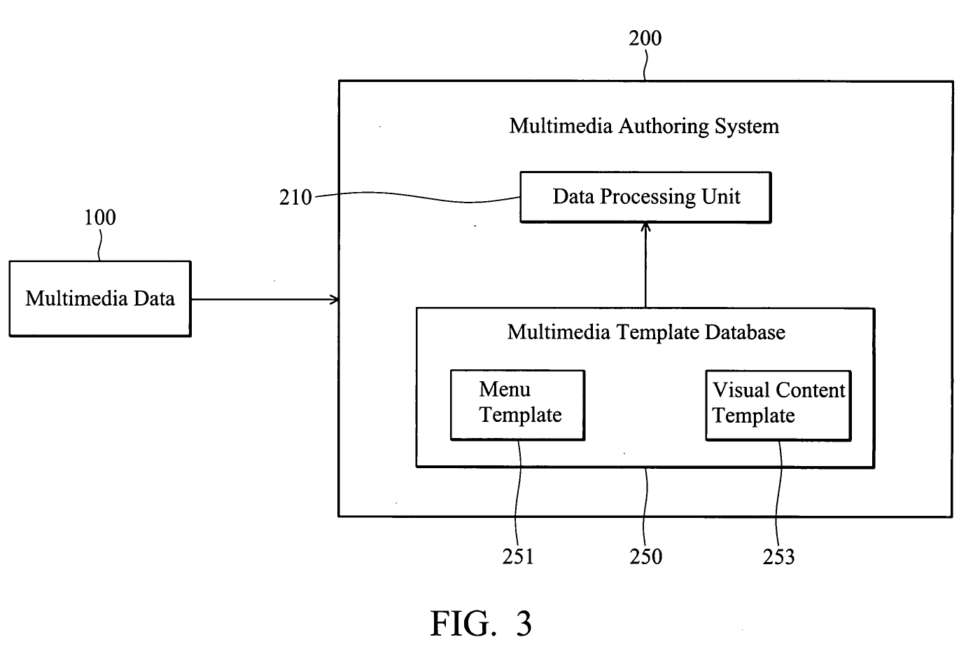

FIG. 3 is a schematic diagram showing the architecture of the multimedia authoring system of an embodiment of the present invention.

A multimedia authoring system 200 comprises a data processing unit 210 and a multimedia template database 250, including menu template 251 and visual content template 253.

To edit photo or video images, one theme template is selected from multimedia template database 250. Multimedia authoring system 200 acquires the preset settings from menu template 251 and visual content template 253 for application to multimedia data 100.

It is determined whether the menu and visual content settings have been customized. If the theme template is customized, customized menu and visual content settings are changed to the selected theme template, and, if not, the process concludes.

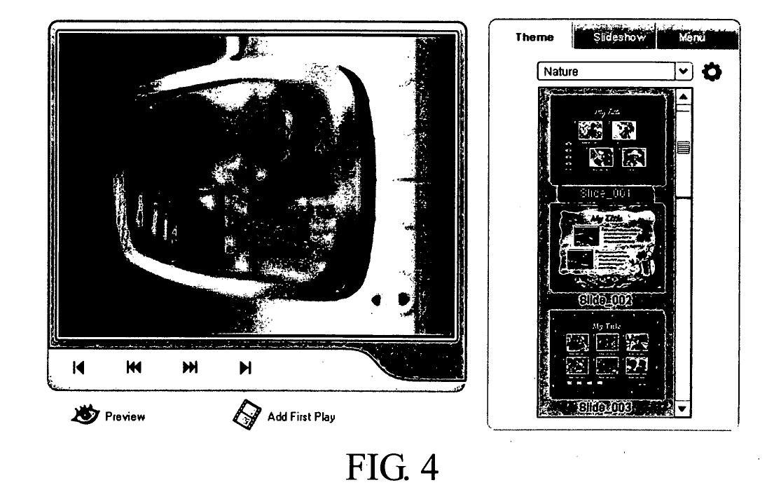

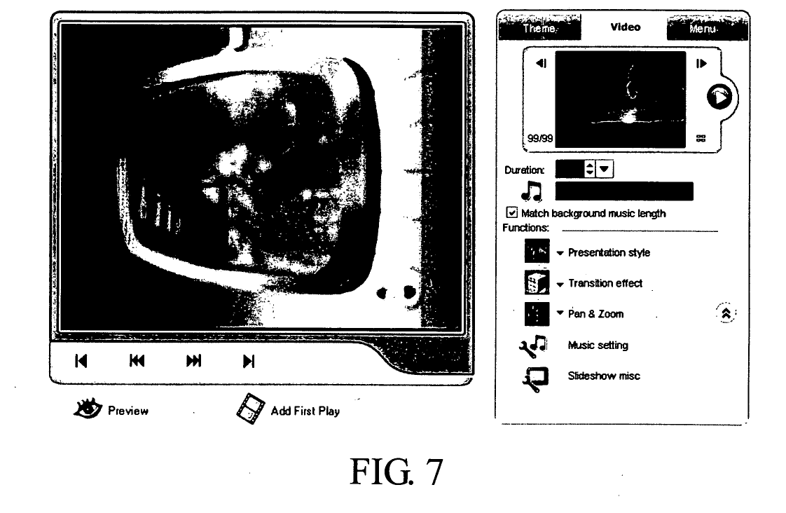

FIG. 4˜FIG. 7 describe a created project with multimedia authoring using theme templates of the embodiment of the present invention.

A new project is first created, selecting one disc format, such as a VCD/SVCD/DVD disc format. Next, favorite pictures and films and individualized settings are added for customizing visual content objects of the project. After that, one theme template style can be applied to those objects, choosing and showing objects with different visual effects by viewers. As shown in FIG. 4, one theme template category “Nature” is selected, displaying all theme templates, and a desirable theme template is selected to be applied, creating several menu pages with each showing several visual content objects, which can be slides or videos. A disc without customization can be thus created, convenient and efficient for users.

In this process, presets in both menu and visual content of a selected theme template are applied to the project. Specific style, for example, relating to background image/video, navigation button, and menu layout is provided to the selected theme template, other settings, comprising background music/audio, menu transition, and others, are also predefined. Moreover, visual content parameters, comprising duration, transition, background music/audio, and others, are predefined for the selected theme template.

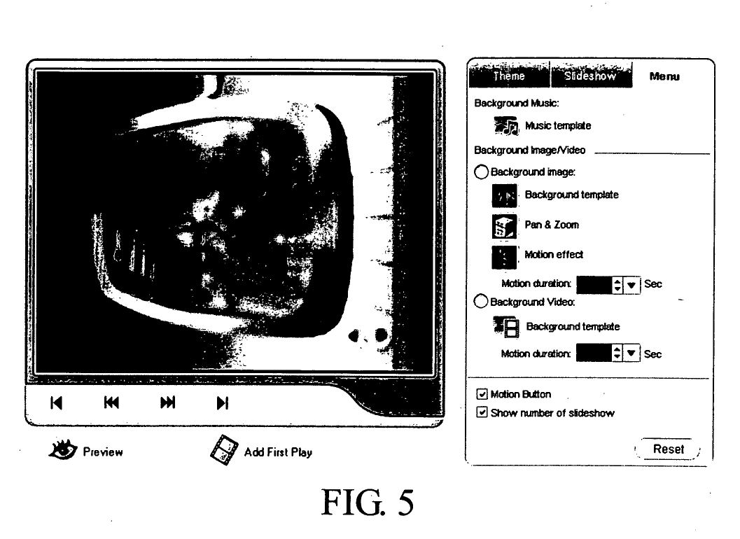

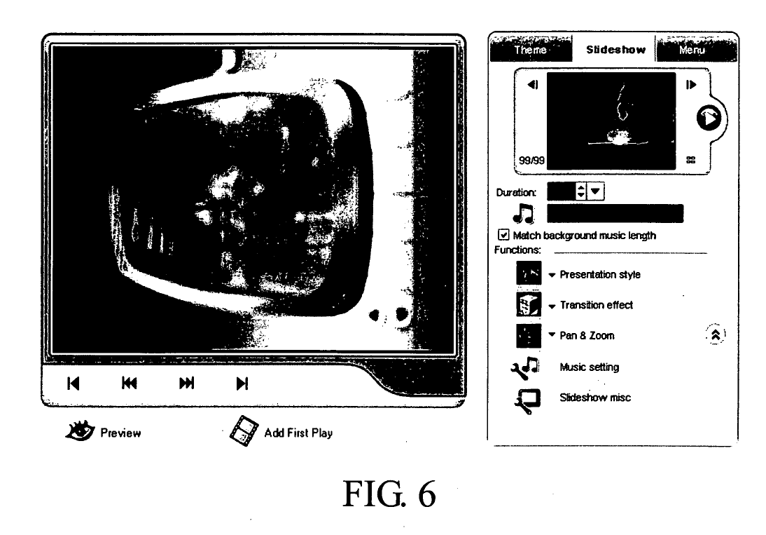

Further, the menu and visual content templates can be adjusted respectively. As shown in FIG. 5, one menu parameter is the background music, determined for the background music of the created project. Menu parameters for the background image comprise background template, pan and zoom, and motion effect with determining the period of motion duration. Another one for the background video is the background template. Motion duration for the background image/video can be defined to adjust duration between clips. Further, for slideshow or video settings of the project, as shown in FIG. 6 and FIG. 7 respectively, the duration item can be assigned and the match option is selected to correlate to the background music. Visual content parameters, referring to slideshow or video parameters, comprise presentation style, transition effect, pan and zoom, music setting, and slideshow misc., adjusted to generate pleasant production.

In other words, users select a theme template (shown in FIG. 4), thus providing a menu authoring interface (shown in FIG. 5) and a visual content authoring interface for a project. The menu authoring interface provides exterior effects and additional controls, enabling users to have individual modification. Both slideshow and video authoring belong to visual content authoring. As shown in FIG. 6, a visual content authoring interface of the embodiment provides slideshow effects to the project and, similar to menu authoring, additional controls, enabling users to have individual modification. Further, a visual content authoring interface of another embodiment provides video effects to the project, as shown in FIG. 7, the video effects comprising identical functions with that of the slideshow effects.

Embodiments of the present invention provide a bi-level theme template structure, integrating menu presets and visual content presets, shortening the workflow for a multimedia authoring system.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A multimedia authoring method using theme templates, comprising the steps of:
providing a multimedia template database, comprising a plurality of theme templates, each theme template comprising a menu template and a visual content template, both comprising predetermined menu and visual content parameters respectively, wherein each theme template is a bi-level structure;
obtaining multimedia data; and
selecting one theme template according to user control for application of a menu template and a visual content template of the selected theme template to the multimedia data respectively.

2. The method as claimed in claim 1, wherein the menu and visual content templates are individual objects, wherein the visual content template is a video or slideshow template.

3. The method as claimed in claim 1, wherein the menu parameter provides background image or background video.

4. The method as claimed in claim 3, wherein the menu parameter further provides navigation button.

5. The method as claimed in claim 4, wherein the menu parameter further provides menu layout, background music/audio, text color and text style, scene, frame, or still and motion filter effects.

6. The method as claimed in claim 1, wherein the visual content parameter provides duration, transition, background music/audio, text color and text style, frame, layer, prop, still and motion filter effects, Pan and Zoom, or presentation style.

7. The method as claimed in claim 1, further comprising the step of customizing the menu or visual content parameters.

8. A storage medium for a computer program providing a multimedia authoring method using theme templates, comprising using a computer to:
providing a multimedia template database, comprising a plurality of theme templates, each theme template comprising a menu template and a visual content template, both comprising predetermined menu and visual content parameters respectively, wherein each theme template is a bi-level structure;
obtaining multimedia data; and
selecting one theme template according to user control for application of a menu template and a visual content template of the selected theme template to the multimedia data respectively.

9. The storage medium as claimed in claim 8, wherein the menu and visual content templates are individual objects, wherein the visual content template is a video or slideshow template.

10. The storage medium as claimed in claim 8, further customizing the menu or visual content parameters.

11. A multimedia authoring system using theme templates, comprising
a multimedia template database, storing a plurality of theme templates, each theme template comprising a menu template and a visual content template, both comprising predetermined menu and visual content parameters respectively, wherein each theme template is a bi-level structure;
a data processing unit, obtaining multimedia data, and selecting one theme template according to user control for application of a menu template and a visual content template of the selected theme template to the multimedia data respectively.

12. The system as claimed in claim 11, wherein the menu and visual content templates are individual objects, wherein the visual content template is a video or slideshow template.

13. The system as claimed in claim 11, wherein the menu parameter provides background image or background video, and navigation button.

14. The system as claimed in claim 13, wherein the menu parameter further provides menu layout, background music/audio, text color and text style, scene, frame, or still and motion filter effects.

15. The system as claimed in claim 11, wherein the visual content parameter provides duration, transition, background music/audio, text color and text style, frame, layer, prop, still and motion filter effects, Pan and Zoom, or presentation style.
